(19) United States
(12) Patent Application Publication
(10) Pub. No.: US 2015/0154378 A1
(43) Pub. Date: Jun. 4, 2015

(54) APPARATUS AND METHOD FOR DISPENSING MEDICATIONS

(71) Applicant: Xerox Corporation, Norwalk, CT (US)

(72) Inventors: Linn C. Hoover, Webster, NY (US); Paul R. Austin, Webster, NY (US); Steven R. Moore, Pittsford, NY (US); Wendell Lewis Kibler, Rochester, NY (US); Denise L. Fletcher, Simsbury, CT (US); Naveen Sharma, Fairport, NY (US)

(73) Assignee: Xerox Corporation, Norwalk, CT (US)

(21) Appl. No.: 14/095,190

(22) Filed: Dec. 3, 2013

(51) Int. Cl. G06F 19/00; A61J 7/04; A61J 7/00

(52) U.S. Cl. CPC G06F 19/3462; A61J 7/0084; A61J 7/0481; A61J 2007/0454

(57) ABSTRACT

A computer-based apparatus including: a cassette including a plurality of compartments for storing medications; and a dispenser including a processor and memory storing computer readable instructions and information for a plurality of medications, the information including dosages and schedules for the medications. The processor is configured to extract a medication from the plurality of medications from a compartment according to the information. The processor is configured to: receive, from a second computer remote from the apparatus, an input including a modification to the information; or create a modification to the information. The processor is configured to determine that a medication stored in the compartment is the same as the medication in the plurality of medications and extract, using the dispenser, a quantity of the stored medication from the compartment according to the modification; or terminate extraction, by the dispenser, of the stored medication from the compartment according to the modification.

### TECHNICAL FIELD

The present disclosure relates to an apparatus and method for automatically dispensing medications, in particular, dynamically adjusting medication regimens according to input received from a remote entity or according to a modification created by the apparatus

### BACKGROUND

Medication is the first and often least invasive solution used by medical doctors for health issues today; however medications can interact with each other, in some cases reducing their effectiveness or even constituting a safety issue. Compounding this is the fact that a patient may have several doctors and specialists who do not directly coordinate treatments of the patient. A patient, or in some cases a caregiver, friend, or family member, typically must coordinate the various prescriptions and pills associated with a patient's medication regimen, for example by filling one or more “daily” pillboxes.

It is know to use a “smart” pillbox incorporating a timer, reminder lights and sounds, and ability to sense that pills have been removed from the pillbox. Some such pillboxes also record adherence, and can notify a caregiver if too much time elapses or too many doses are missed. Similarly, medication reminder apps for mobile devices are known. However, both “smart” pillboxes and mobile device apps require the patient or caregiver to prepare and enter the reminder regimen and any updates to a medication regimen.

U.S. Pat. No. 7,454,880 B1 teaches a system approach that permits medication regimens to be professionally coordinated and designed by a pharmacist, and packed into foil sealed blisters. This approach is effective in some aspects, but increases the workload on the pharmacy, and is inflexible for changes to the medication regimen. Further, this approach cannot accommodate missed dosages or pro re nata (PRN) medications. It is difficult to automate the filling and validation of blister packages in large quantities, and postage costs are increased if medications are mailed in smaller time increments.

U.S. Pat. No. 6,145,697 discloses a device for enabling a patient to have ready access to a daily dosage of medication placed in compartments at predetermined time periods. Specific dosages in the form of capsules or pills are sequentially placed in selected compartments. This approach also is inflexible for changes in the medication regimen and cannot accommodate missed dosages or PRN medications.

U.S. Patent Application Publication No. 2002/113077 discloses a medication dispensing system comprising an on-site medication dispensing unit and a central monitoring facility. The on-site medication dispensing unit holds bulk amounts of medication in a plurality of separate receptacles from which it selects a desired medication dosage according to an entered and stored prescription regimen. This approach also is inflexible for changes in the medication regimen and cannot accommodate missed dosages or PRN medications.

Medication adherence, including patient adherence to medication regimens is an important aspect of any system providing medical services. Specifically, lack of medical adherence has a negative effect on outcomes and increases costs associated with providing medical services. The lack of flexibility and adaptability noted in the approaches described above adversely impacts adherence.

### SUMMARY

According to aspects illustrated herein, there is provided a computer-based apparatus for dispensing medications, including: a dispenser; and a cassette including a plurality of compartments arranged to hold a plurality of stored medications; a first computer with a processor and a memory element configured to store computer readable instructions and first information for a plurality of medications. The first information includes a first respective dosage for each medication in the plurality of medications and a plurality of time spans, including respective points in time within each time span, for dispensing a portion of the plurality of medications, or at least one parameter for dispensing a portion of the plurality of medications on a pro re nata (PRN) basis. The processor is configured to execute the computer readable instructions to determine that the first information includes instructions to extract a first medication included in the portion of the plurality of medications from a first compartment included in the plurality of compartments. The processor is configured to execute the computer readable instructions to receive, from a second computer remote from the first computer, a first input including a first modification to the first information for the first medication or create a first modification to the first information for the first medication. The processor is configured to execute the computer readable instructions to determine that a first stored medication in the first compartment is the same as the first medication and extract, using the dispenser, a first quantity of the first stored medication from the first compartment in accordance with the first modification, or terminate extraction, by the dispenser, of the first stored medication from the first compartment in accordance with the first modification.

According to aspects illustrated herein, there is provided a computer-based system for controlling dispensing of medications, including: a service entity including a first computer with a first processor and a first memory element configured to store first computer readable instructions; and a dispensing apparatus including a cassette including a plurality of compartments arranged to hold a plurality of stored medications, a second computer including a second processor and a second memory element configured to store second computer readable instructions, and a dispenser. The first processor is configured to execute the first computer readable instructions to: receive at least one first input, including at least one prescription for at least one medication, from at least one health care provider or pharmacy entity providing the at least one medication; create information including a respective dosage for each medication included in the at least one medication and at least one time span and respective point in time within the at least one time span for dispensing at least a portion of the at least one medication, or at least one parameter for dispensing at least a portion of the at least one medication on a pro re nata (PRN) basis; and transmit the information to the second computer. The second processor is configured to execute the second computer readable instructions to extract, using the dispenser, medications stored in the plurality of compartments according to the information. The first processor is configured to execute the first computer readable instructions to: receive a second input including a change to the respective dosage, the at least one time span, or the at least one parameter; modify the information to include the second input; and transmit the modified information to the second compute. The second processor is configured to execute the second computer readable instructions to extract, using the dispenser, medications stored in the plurality of compartments according to the modified information.

According to aspects illustrated herein, there is provided a computer-based method for dispensing medications, including: storing in a memory element for a first computer for a dispensing apparatus computer readable instructions and first information for a plurality of medications, the first information including a first respective dosage for each medication in the plurality of medications and a plurality of time spans, including respective points in time within each time span, for dispensing a portion of the plurality of medications, or at least one parameter for dispensing a portion of the plurality of medications on a pro re nata (PRN) basis; executing, using a processor for the first computer, the computer readable instructions to determine that the first information includes instructions to extract a first medication, included in the portion of the plurality of medications, from a first compartment included in a plurality of compartments for a cassette for the dispensing apparatus, the plurality of compartments arranged to hold a plurality of stored medications; executing, using the processor, the computer readable instructions to: receive, from a second computer remote from the first computer, a first input including a first modification to the first information for the first medication, or create a first modification to the first information for the first medication; and executing, using the processor, the computer readable instructions to: determine that a first stored medication in the first compartment is the same as the first medication; and extract, using a dispenser for the dispensing apparatus, a first quantity of the first stored medication from the first compartment in accordance with the first modification, or terminate extraction, by the dispenser, of the first stored medication from the first compartment in accordance with the first modification.

According to aspects illustrated herein, there is provided a computer-based method for controlling dispensing of medications, including: storing first computer readable instructions in a first memory element for a first computer for a service entity; storing second computer readable instructions in a second memory element for a second computer for a dispensing apparatus; executing, using a first processor for the first computer, the first computer readable instructions to: receive at least one first input, including at least one prescription for at least one medication, from at least one health care provider or pharmacy entity providing the at least one medication, create information including: a respective dosage for each medication included in the at least one medication and at least one time span and respective point in time within the at least one time span for dispensing at least a portion of the at least one medication, or at least one parameter for dispensing at least a portion of the at least one medication on a pro re nata (PRN) basis, and transmit the information to the second computer; executing, using a second processor for the second computer, the second computer readable instructions to extract, using a dispenser for the dispensing apparatus, medications stored in a plurality of compartments for a cassette for the dispensing apparatus according to the information; executing, using the first processor, the first computer readable instructions to: receive a second input including a change to the respective dosage, the at least one time span, or the at least one parameter, modify the information to include the second input and transmit the modified information to the second computer; and executing, using the second processor, the second computer readable instructions to extract, using a dispenser for the dispensing apparatus, medications stored in the plurality of compartments according to the modified information.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of a computer-based apparatus for dispensing medications;

FIG. 1A is a schematic detail of the memory element of FIG. 1;

FIG. 1B is a schematic detail of the processor of FIG. 1;

FIG. 2 is a schematic exploded representation of an example of the dispensing apparatus in FIG. 1;

FIG. 3 is a schematic cross-sectional view of the example dispensing apparatus in FIG. 2;

FIG. 4 is a schematic representation of a top view of an example cassette for the dispensing apparatus in FIG. 3;

FIG. 5 is a schematic representation of a view of an example lid for the cassette in FIG. 4; and,

FIG. 6 is a schematic block diagram of a computer-based system for controlling dispensing of medications.

### DETAILED DESCRIPTION

Moreover, although any methods, devices or materials similar or equivalent to those described herein can be used in the practice or testing of these embodiments, some embodiments of methods, devices, and materials are now described.

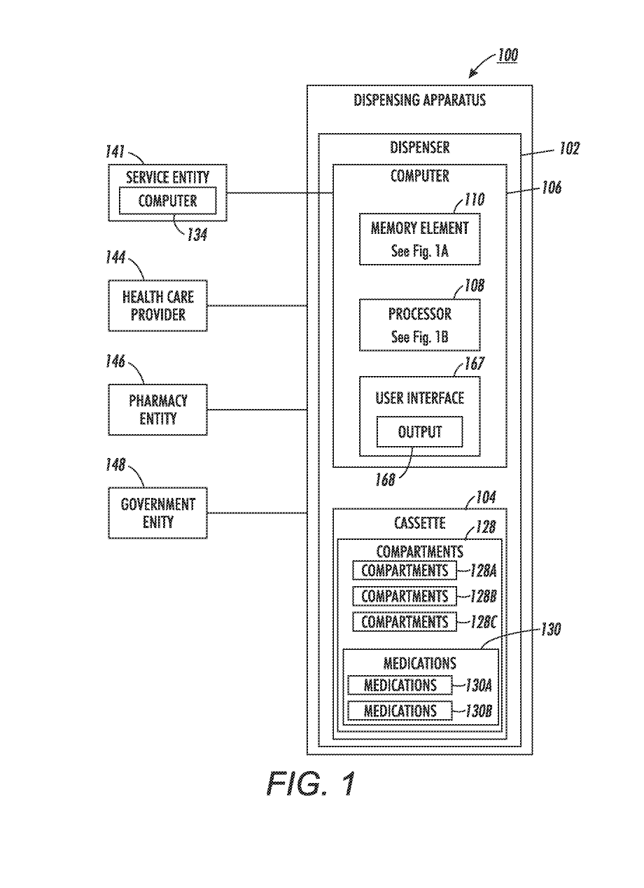

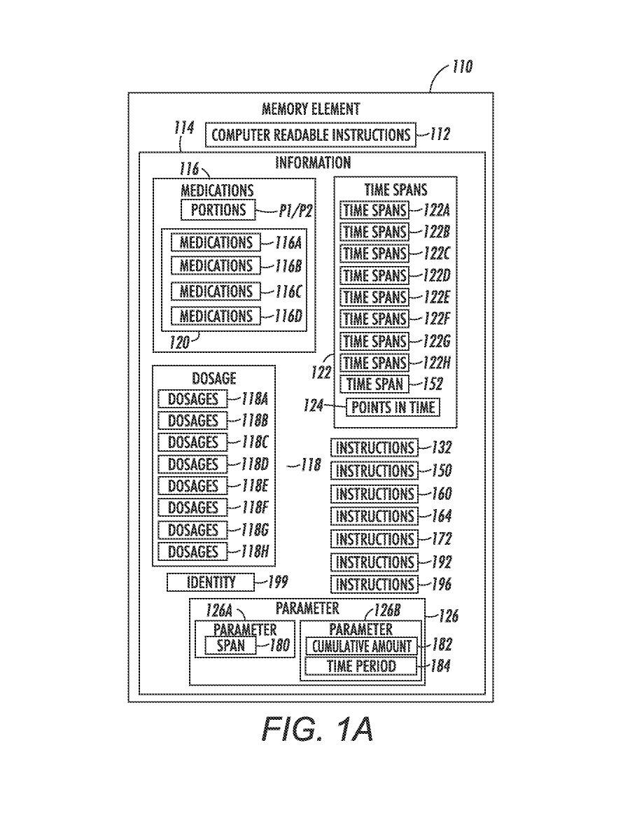

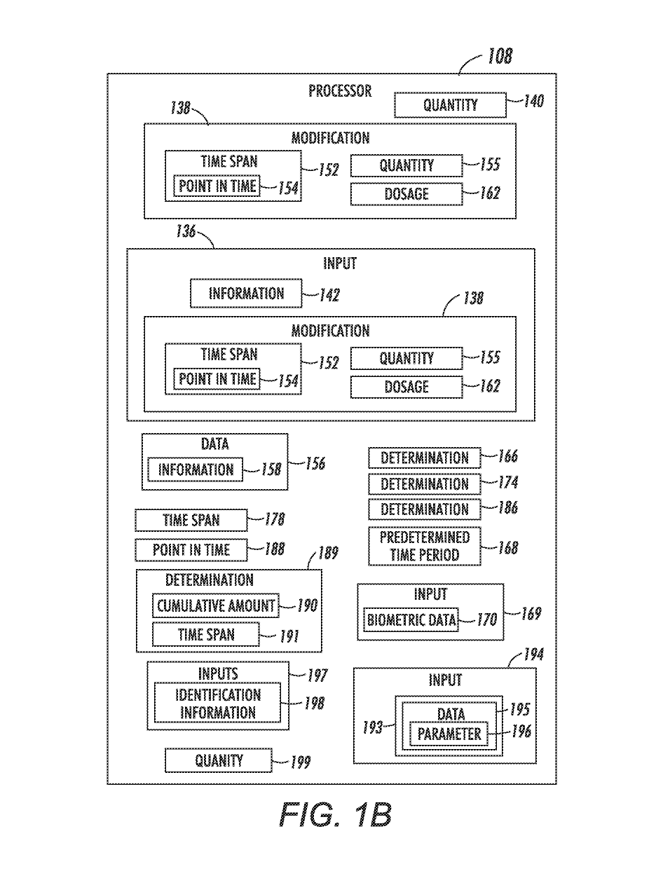

FIG. 1 is a schematic block diagram of computer-based apparatus 100 for dispensing medications.

FIG. 1A is a schematic detail of the memory element of FIG. 1.

FIG. 1B is a schematic detail of the processor of FIG. 1. The following should be viewed in light of FIGS. 1 through 1B. Apparatus 100 includes dispenser 102 and cassette 104. Dispenser 102 includes computer 106 with processor 108 and memory element 110 configured to store computer readable instructions 112 and information 114 for medications 116. Information 114 includes: respective dosage 118 for each medication in medications 116, and time spans 122, including respective points in time 124 within each time span for dispensing portion P1 of medications 116; or at least one parameter 126 for dispensing portion P2 of medications 116 on a pro re nata (PRN), or “as-needed” basis. Cassette 104 includes compartments 128 arranged to hold stored medications 130.

Processor 108 is configured to execute computer readable instructions 112 to determine information 114 includes instructions 132 to extract medication 116A included in portion P1 from compartment 128A included in compartments 128. Hereinafter, it is understood that the term “processor 108 is configured to” is the same as “processor 108 is configured to execute computer readable instructions 112 to”. Processor 108 is configured to: receive, from computer 134, remote from computer 106, input 136 including modification 138 to information 114; or create modification 138. Processor 108 is configured to determine that stored medication 130A in compartment 128A is the same as medication 116A and extract, using the dispenser, quantity 140 of medication 130A from compartment 128A in accordance with modification 138, or terminate extraction, by the dispenser, of medication 130A from compartment 128A in accordance with modification 138. In an example embodiment, computer 134 is operated by service entity 141. A service entity is further described below.

Medications 128 are in the form of pills or capsules. In an example embodiment, dispenser 102 is configured to extract pills or capsules one at a time, using any means known in the art, as necessary to fulfill a particular dosage 118.

In an example embodiment, input 136 includes information 142 provided by health care provider 144, pharmacy entity 146 that supplied medication 116A, or governmental agency 148 regulating manufacture or distribution of medication 116A. In an example embodiment, medication 116A is a prescription medication and health care provider 144 wrote a prescription for medication 116A. Thus, apparatus 100 dynamically adapts information 114 (including the regimen for medication 116A) to accommodate changes to the information/regimen made by the health care provider or pharmacy entity. For example, the health care provider may receive lab results that necessitate a change to dosage 118 or time span 122 for medication 116A. Apparatus 100 receives the change via input 136 and automatically updates information 114 and the dispensing of medication 116A without requiring the patient or care giver to make any adjustment to apparatus 100 themselves. In the case of input 136 from agency 148, input 136 could include a warning to modify a dosage or to avoid taking medication 116A with another medication 116, and apparatus 100 automatically makes the required adjustment without requiring the patient or care giver to make any adjustment to apparatus 100 themselves.

In an example embodiment, information 114 includes instructions 150 to extract dosage 118A of medication 116A at time span 122A included in time spans 122. Modification 138 identifies time span 152 with point in time 154, and the processor is configured to extract, using the dispenser and within time span 152: quantity 140 of medication 130A from compartment 128A; or quantity 155, different from quantity 140, of medication 130A from compartment 128A. In an example embodiment, time span 152 is included in time spans 122. Thus, apparatus 100 automatically and dynamically accommodates changes in the schedule for taking a medication.

In an example embodiment, the processor is configured to block, using the dispenser, extraction of medication 116A within time span 122A. Thus, apparatus 100 automatically and dynamically prevents extraction of a medication within a particular time frame as required by modification 138. In an example embodiment, time span 152 precedes time span 122A in a chronological sequence; or time span 152 follows time span 122A in a chronological sequence. In an example embodiment, input 136 includes time span 152 or the processor is configured to calculate time span 152. In an example embodiment, input 136 includes quantity 155 or the processor is configured to calculate quantity 155.

In an example embodiment, the processor is configured to create data 156 regarding medications 116 or 130. Processor 108 is configured to generate modification 138 according to data 156 or the processor is configured to transmit data 156 to computer 134. In the latter case, computer 134 is configured to create input 136 in response to data 156. In an example embodiment, data 156 is a log recording extraction of medications 130 from apparatus 100, for example, recording when particular medications 116 have been extracted and the respective dosages of the medications extracted. In an example embodiment, data 156 includes information 158 regarding compliance with dosages 118, time spans 122, or the at least one parameter 126.

For example, if a patient fails to take medication 116A according to time span 122 for the medication, apparatus 100 or computer 134 automatically determines if adjustments to information 114 are needed (for any or all medications 116) and automatically generates the adjustment (modification 138). In turn, apparatus 100 automatically implements the adjustment. For example, in response to a request for a PRN medication, apparatus 100 or computer 134 reviews log information included in data 156 for the requested medication and determines if the request is compliant with information 114, for example, is the request far enough in time from a previous extraction of the medication. If the request is compliant, apparatus 100 dispenses the requested medication according to information 114 and modification 138.

In an example embodiment, information 114 includes instructions 160 to extract dosage 118B of medication 116A at time span 122B included in time spans 122. Modification 138 identifies dosage 162 of medication 116A, and the processor is configured to extract, using the dispenser, dosage 162 of medication 130A from compartment 128A within time span 122B. In an example embodiment, input 136 includes dosage 162. In an example embodiment, the processor is configured to calculate dosage 162. Thus, apparatus 100 accommodates concurrent changes to dosages and scheduling for a medication.

In an example embodiment, the processor is configured to determine that information 114 includes instructions 164 to extract, using the dispenser, dosage 118C of medication 116A at time span 122C: included in time spans 122. The processor is configured to make determination 166 that medication 130A: has not been extracted from the cassette by the dispenser within time span 122C; or has been extracted from cassette 104 by the dispenser within time span 122C and not removed from the dispenser within predetermined time period 168. In an example embodiment, the processor is configured to create modification 138 in response to determination 166. In an example embodiment, the processor is configures to transmit determination 166 to computer 134 and computer 134 is configured to create modification 138 using determination 166.

In an example embodiment, dispenser 102 includes user interface 167. The processor is configured to provide sensory output 168 via the user interface to alert the patient or care giver that it is time to receive a medication or medications 116 from apparatus 100. In an example embodiment, the processor is configured to receive input 169 from the user interface to trigger extraction of a medication or medications according to information 114. In an example embodiment, input 169 includes biometric data 170, and the processor is configured to confirm that biometric data 170 is for a patient for whom medications 116 are intended or an agent authorized to obtain medications 116 from the dispenser for the patient, and in response to confirming biometric data 170, extract, using the dispenser, quantity 140 of medication 130A from compartment 128A in accordance with modification 138.

In an example embodiment, for a PRN medication, user interface 167 displays a menu listing available PRN medications and the patient or care giver is able to select a medication from the menu and request the medication. As noted above, apparatus 100 or computer 134 reviews the request.

In an example embodiment, information 114 includes instructions 172 to extract, using the dispenser, dosage 118D of medication 116A at time span 122D included in time spans 122. The processor is configured to make determination 174 that an input requesting extraction of medication 116A has not been received by the dispenser within time span 178 before or after time span 122D. In an example embodiment, the processor is configured to create modification 138 in response to determination 174. In an example embodiment, the processor is configured to transmit determination 174 to computer 134 and computer 134 is configured to create modification 134 using determination 174. Thus apparatus automatically and dynamically adjusts for missed dosages of a medication and enables the time period for detecting such missed dosages to be set.

In an example embodiment, the at least one parameter 126 includes parameter 126A specifying time span 180 between extractions of medication 116A, or parameter 126B specifying a cumulative amount 182 of medication 116A extracted within time period 184. Modification 138 includes a change to parameter 126A and/or parameter 126B. For example, changes to parameter 126A or 126B can be made by a health care provider according to results of lab tests or a physical examination or to account for pharmacokinetic affects related to addition of a new medication to a patient's medication regimen or a change in dosage of an existing medication in the medication regimen.

In an example embodiment, information 114 includes dosage 118E for medication 116B in medications 116 and time span 122E, included in time spans 122, for dispensing medication 116B. The processor is configured to make determination 186 that dosage 118E has not been extracted within time span 122E and has been extracted at point in time 188 outside of time span 122E. That is, a medication has been extracted at a time outside of compliance with a regimen for the medication. In an example embodiment, the processor is configured to make determination 189 that cumulative amount 190 of PRN medication 116B has been extracted within time span 191. Thus, apparatus 100 tracks cumulative dosages of the PRN medication. In an example embodiment, the processor is configured to create modification 138 in response to determination 189. In an example embodiment, the processor is configures to transmit determination 189 to computer 134 and computer 134 is configured to create modification 138 using determination 189.

In an example embodiment, the processor is configured to determine that information 114 includes instructions 192 to extract, using the dispenser: dosage 118F of medication 116A within time span 122F included in time spans 122; or medication 116A in compliance with the at least one parameter 126. The processor is configured to determine that stored medication 130B in compartment 128B included in compartments 128 is the same as medication 116C included in medications 116. The processor is configured to extract, using the dispenser: dosage 118G of stored medication 130B from compartment 128B within time span 122G included in time spans 122; or stored medication 130B in compliance with parameter 126.

Modification 138 includes a change to dosage 118F, or time span 122F, or parameter 126. The processor is configured to modify, according to modification 138: dosage 118G, time span 122G, or parameter 126 with respect to medication 116C. Apparatus 100 accounts for “cascading” impacts on information 114 due to modification 138. For example, if modification 138 changes the dosage or dosage schedule of medication 116A, apparatus 100 or computer 134 determines that the changes require changes to the dosage or dosage schedule for medication 116C. Apparatus 100 then modifies information 114 for medication 116C accordingly and implements the modified information 114 for medication 116C. Thus, apparatus 100 adjusts for one medication due to non-compliance for another medication or due to a cumulative dosage of another medication. Stated otherwise, apparatus 100 monitors and adjusts for interaction between medications.

In an example embodiment, information 114 includes identity 193 of a patient for whom medication 116A is prescribed. The processor is configured to: receive, from the user interface, input 194 including data 195 regarding parameter 196 related to health of the patient; and create, in response to input 194, modification 138; or transmit data 195 to computer 134. In an example embodiment, computer 134 is configured to create modification 138 using data 195. For example, the patient, the care giver for the patient, or a health care provider at the location of apparatus 100 can input data such as blood pressure readings, blood sugar levels etc. In general, any health-related data known in the art can be inputted. Apparatus 100 also can interface directly with devices obtaining data 195 from the patient. Thus, apparatus 100 can modify information 114 immediately, automatically, and dynamically according to real time conditions.

In an example embodiment, information 114, for each patient includes: respective dosage 118H for respective medication 116D in medications 116; and respective time span 118H included time spans 122 for dispensing respective medication 116D; or at least one respective parameter 126 for dispensing respective medication 116D on a PRN basis. The processor is configured to determine that information 114 includes instructions 196 to extract each respective medication 116D from respective compartment 128C included compartments 128. The processor is configured to receive inputs 197 including identification information 198; confirm that identification information 198 is one of the patients. The processor is configured to extract, using the dispenser, respective quantity 199 of respective medication 116D for the patient from respective compartment 128C in accordance with modification 138, or terminate extraction, by the dispenser, of the respective quantity 199 of respective medication 116D for the patient from respective compartment 128C in accordance with modification 138.

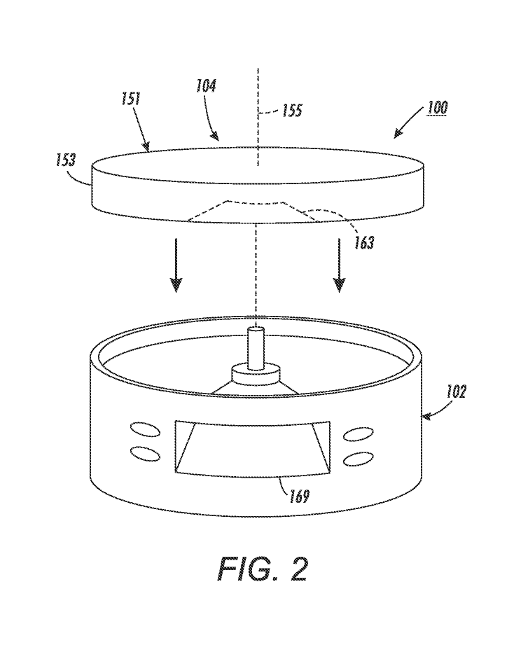

FIG. 2 is a schematic exploded representation of an example of dispensing apparatus 100 in FIG. 1.

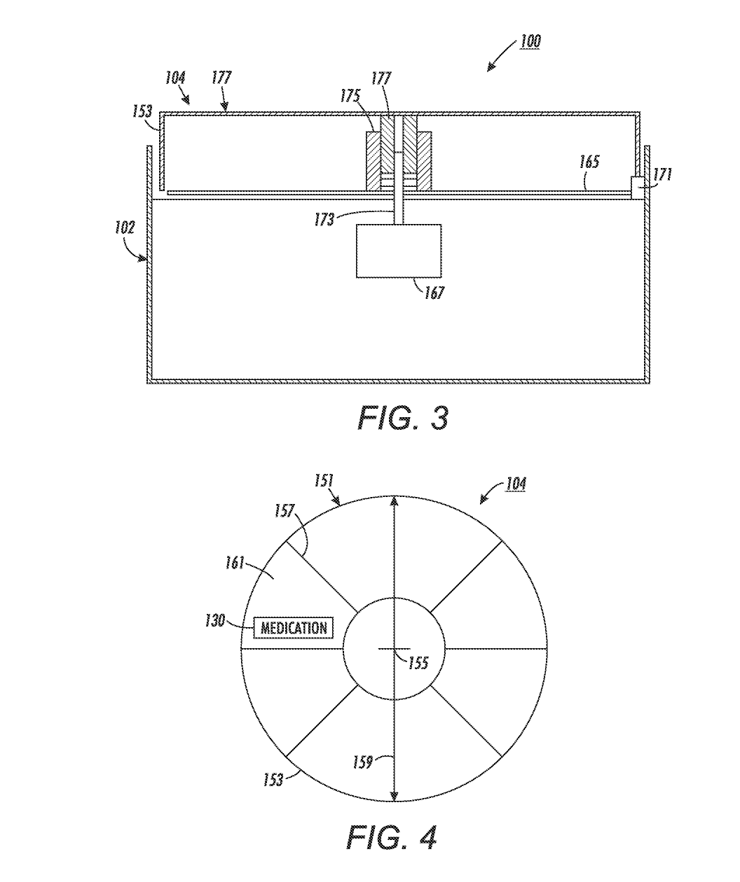

FIG. 3 is a schematic cross-sectional view of the dispensing apparatus 100 in FIG. 2.

FIG. 4 is a schematic representation of a top view of an example cassette for dispensing apparatus 100 in FIG. 3.

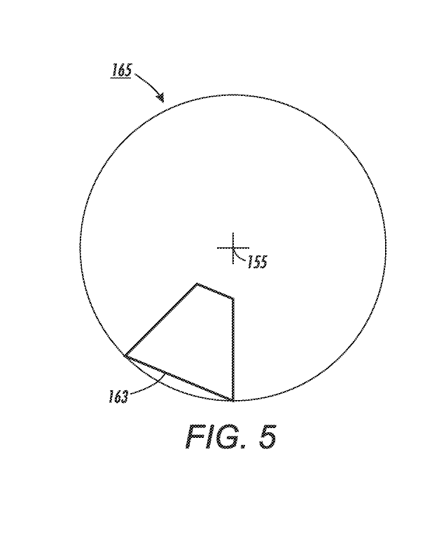

FIG. 5 is a schematic representation of a view of an example lid for the cassette in FIG. 4. The following should be viewed in light of FIGS. 1 through 5. In an example embodiment, cassette 104 includes body 151 with rigid outer cylindrical wall 153, central axis 155, radial walls 157 separating the compartments. However, it should be understood that other shapes and configurations are possible for cassette 104. Cassette 104 can be a one piece plastic molding and can either be transparent or opaque. In the example of FIG. 4, eight compartments are shown; however, it should be understood that cassette 104 is not limited to any particular number of compartments and that other numbers of compartments are possible. Outside diameter 159 can be selected according to the configuration and size of element 102 or as needed to provide the desired number and size of compartments 161 in the cassette used to store medications 130.

In an example embodiment, each compartment 161 includes a port 163 that is an opening in lid 165 of the cassette. The lid is attached to the body and is rotatable about central axis 155 using actuator 167, which can be any actuator known in the art. The lid also can be a molded plastic part and port 163 an aperture corresponding to the size and shape of one compartment 161. Thus, when lid 165 is rotated to align port/aperture 163 with a compartment, all the medications in the compartment fall out of the compartment by gravitational force into dispensing port 169. Cassette 104 can be shipped so that port/aperture 163 is locked into position corresponding to an empty reserve compartment, for example by anti-rotation feature 171. When the cassette is installed in dispensing device 102 and has been confirmed as being a correct cassette, the locking of the lid is removed and at the appropriate time, actuator 167 rotates the lid to align with the appropriate compartment 161.

In an example embodiment, dispenser 102 includes lid drive gear shaft 173, lid 165 includes hub 175, and body 151 includes hub 177. Hubs 175 and 177 enable relative rotation of the lid and body 151.

Thus, apparatus 100 can provide and control medications for a plurality of patients. This aspect of apparatus 100 is particularly advantageous for a clinic, health care provider office, hospital, or other facility providing health care services. All the functions described above for a single patient are applicable to each patient for the case in which information 114, medications 116, and medications 128 pertain to a plurality of patients.

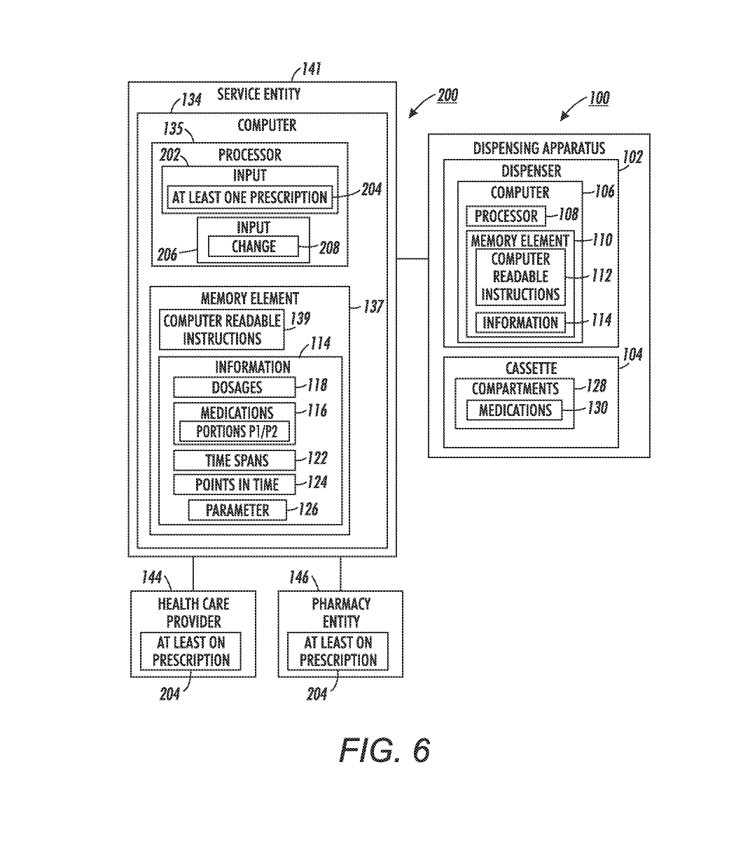

FIG. 6 is a schematic block diagram of computer-based system 200 for controlling dispensing of medications. System 200 includes apparatus 100 and computer 134 operated by service entity 134. Computer 134 includes processor 135 and memory element 137 configured to store computer readable instructions 139. Apparatus 100 includes dispenser 102 and cassette 104. Dispenser 102 includes computer 106 with processor 108 and memory element 110 configured to store computer readable instructions 112 and instruction 114. Cassette 104 includes compartments 128 arranged to store stored medications 130.

Processor 135 is configured to execute computer readable instructions 139 to: receive at least one input 202, including at least one prescription 204 for at least one medication 116, from at least one health care provider 144 or pharmacy entity 146 providing the at least one medication. Processor 135 is configured to execute computer readable instructions 139 to create information 114 including: respective dosage 118 for each medication 116 included in the at least one medication 116 and at least one respective time span 122 and respective point in time 124 within the at least one respective time span 118 for dispensing respective portion P1; or at least one respective parameter 126 for dispensing respective portion P2 on a PRN basis.

Processor 206 is configured to execute computer readable instructions 139 to transmit information 114 to computer 106. Processor 108 is configured to execute the computer readable instructions 112 to extract, using dispenser 102, medications 130 stored in compartments 128 according to information 114. Processor 135 is configured to execute computer readable instructions 139 to: receive input 206 including change 208 to a respective dosage 118, a respective time span 122, or respective parameter 126; modify information 114 to generate modification 138 including input 206; and transmit modification 138 to computer 106. Processor 108 is configured to execute the computer readable instructions 112 to extract, using the dispenser, medications 130 stored in compartments 128 according to modification 138.

The discussion of apparatus 100 in FIG. 1 is applicable to apparatus 100 in FIG. 6.

Apparatus 100 and system 200 retain the advantages of professional regimen design, and add the flexibility to accommodate changes in the regimen or deviation of a patient from the regimen. Apparatus 100 and system 200 also provide interaction checking and dosage control for pro re nata (PRN) medications.

The extraction mechanism of dispenser 102 and cassette 104 can be any dispenser mechanism and cassette known in the art. Cassette 104 can be supplied with medications 128 using any means known in the art. In an example embodiment, apparatus 100 includes any printer known in the art configured to generate a print of instructional data transmitted by processor 106 or computer 134 to the printer.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based apparatus for dispensing medications, comprising:
a cassette including a plurality of compartments arranged to hold a plurality of stored medications;
a first computer with:
a processor; and,
a memory element configured to store:
computer readable instructions; and,
first information for a plurality of medications, the first information including:
a first respective dosage for each medication in the plurality of medications; and,
a plurality of time spans, including respective points in time within each time span, for dispensing a portion of the plurality of medications; or,
at least one parameter for dispensing a portion of the plurality of medications on a pro re nata (PRN) basis; and,
a dispenser, wherein:
the processor is configured to execute the computer readable instructions to determine that the first information includes instructions to extract a first medication included in the portion of the plurality of medications from a first compartment included in the plurality of compartments;
the processor is configured to execute the computer readable instructions to:
receive, from a second computer remote from the apparatus, a first input including a first modification to the first information for the first medication; or,
create a first modification to the first information for the first medication; and,
the processor is configured to execute the computer readable instructions to:
determine that a first stored medication in the first compartment is the same as the first medication; and,
extract, using the dispenser, a first quantity of the first stored medication from the first compartment in accordance with the first modification; or,
terminate extraction, by the dispenser, of the first stored medication from the first compartment in accordance with the first modification.

2. The computer-based apparatus of claim 1, wherein the first input includes second information provided by:
a health care provider; or,
a pharmacy entity that supplied the first medication; or,
a governmental agency regulating manufacture or distribution of the first medication.

3. The computer-based apparatus of claim 1, wherein:
the first information includes instructions to extract the first respective dosage of the first medication at a first time span included in the plurality of time spans;
the first modification identifies a second time span with a first point in time; and,
the processor is configured to execute the computer readable instructions to extract, using the dispenser and within the second time span:
the first quantity of the first stored medication from the first compartment; or,
a second quantity, different from the first quantity, of the first stored medication from the first compartment.

4. The computer-based apparatus of claim 3, wherein the second time span is included in the plurality of time spans.

5. The computer-based apparatus of claim 3, wherein the processor is configured to execute the computer readable instructions to block, using the dispenser, extraction of the first medication within the first time span.

6. The computer-based apparatus of claim 3, wherein:
the second time span precedes the first time span in a chronological sequence; or,
the second time span follows the first time span in a chronological sequence.

7. The computer-based apparatus of claim 3, wherein:
the first input includes the second time span or the second quantity or,
the processor is configured to execute the computer readable instructions to calculate the second time span the second quantity.

8. The computer-based apparatus of claim 1,
wherein the processor is configured to execute the computer readable instructions to create second information regarding compliance with the first respective dosages, the plurality of time spans, or the at least one parameter; and,
wherein:
the processor is configured to execute the computer readable instructions to create the first modification using the second information; or,
wherein:
the processor is configured to execute the computer readable instructions to transmit the second information to the second computer; and,
the second computer is configured to create the first input using the second information.

9. The computer-based apparatus of claim 1,
wherein:
the first information includes instructions to extract the first respective dosage of the first medication at a time span included in the plurality of time spans and respective points in time;
the first modification identifies a second dosage of the first medication;
the processor is configured to execute the computer readable instructions to extract, using the dispenser, the second dosage of the first stored medication from the first compartment within the first time span; and,
wherein:
the first input includes the second dosage; or,
the processor is configured to execute the computer readable instructions to calculate the second dosage.

10. The computer-based apparatus of claim 1,
wherein:
the processor is configured to execute the computer readable instructions to:
determine that the first information includes instructions to extract, using the dispenser, the first respective dosage of the medication at a first time span included in the plurality of time spans; and,
make a determination that the first stored medication:
has not been extracted from the cassette by the dispenser within the first time span; or,
has been extracted from the cassette by the dispenser within the first time span and not removed from the dispenser within a predetermined time period; and,
wherein:
the processor is configured to execute the computer readable instructions to create the first modification using the determination; or,
wherein:
the processor is configured to execute the computer readable instructions to transmit the determination to the second computer; and,
the second computer is configured to create the first input using the determination.

11. The computer-based apparatus of claim 1,
wherein:
the first information includes instructions to extract, using the dispenser, the first respective dosage of the medication at a first time span included in the first plurality of time spans; and,
the processor is configured to execute the computer readable instructions to:
make a determination that a second input, requesting extraction of the first medication, has not been received by the dispenser within a second time span before or after the first time span; and,
wherein:
the processor is configured to execute the computer readable instructions to create the first modification using the determination; or,
wherein:
the processor is configured to execute the computer readable instructions to transmit the determination to the second computer; and,
the second computer is configured to create the first input using the determination.

12. The computer-based apparatus of claim 1, wherein:
the at least one parameter for dispensing the portion of the plurality of medications on a PRN basis includes:
a first parameter specifying a second time span between extractions of the first medication; or,
a second parameter specifying a first cumulative amount of the first medication extracted within a first time period; and,
the first modification includes a change to the first or second parameter.

13. The computer-based apparatus of claim 1,
wherein:
the first information includes a second respective dosage for a second medication in the plurality of medications and a second time span, included in the plurality of time spans, for dispensing the second medication;
the processor is configured to execute the computer readable instructions to make a determination that:
the second respective dosage has not been extracted within the second time span and has been extracted at a point in time outside of the second time span; or,
a cumulative amount of the second medication has been extracted within a third time span; and,
wherein:
the processor is configured to execute the computer readable instructions to create the first modification using the determination; or,
wherein:
the processor is configured to execute the computer readable instructions to transmit the determination to the second computer; and,
the second computer is configured to create the first input using the determination.

14. The computer-based apparatus of claim 1, wherein:
the processor is configured to execute the computer readable instructions to determine that the first information includes instructions to extract, using the dispenser:
the first respective dosage of the first medication within a first time span included in the plurality of time spans; or,
the first medication in compliance with the at least one parameter;
the processor is configured to execute the computer readable instructions to:
determine that a second stored medication in a second compartment included in the plurality of compartments is the same as a second medication included in the plurality of medications; and,
extract, using the dispenser:
a first respective dosage of the second stored medication from the second compartment within a second time span included in the plurality of time spans; or,
the second stored medication in compliance with the at least one parameter;
the first modification includes a change to the first respective dosage of the first medication, or the first time span, or the at least one parameter; and,
the processor is configured to execute the computer readable instructions to modify, according to the first modification: the first respective dosage of the second medication, or the second time span, or the at least one parameter with respect to the second medication.

15. The computer-based apparatus of claim 1,
wherein:
the dispenser includes a user interface;
the first information includes an identity of a patient for whom the first medication is prescribed; and,
the processor is configured to execute the computer readable instructions to receive, from the user interface, a second input including data regarding a parameter related to health of the patient; and,
wherein:
the processor is configured to execute the computer readable instructions to create the first modification using the data; or,
wherein:
the processor is configured to execute the computer readable instructions to transmit the data to the second computer; and,
the second computer is configured to create the first input using the data.

16. The computer-based apparatus of claim 1, wherein:
the plurality of compartments is arranged to store a respective stored medication for a plurality of patients;
the first information includes, for each patient in the plurality of patients:
first respective dosage for a respective medication in the plurality of medications; and,
a respective time span included in the plurality of time spans for dispensing the respective medication; or,
at least one respective parameter for dispensing the respective medication on a PRN basis; and,
the processor is configured to execute the computer readable instructions to determine that the information includes respective instructions to extract each respective from a respective compartment included in the plurality of compartments; and,
the processor is configured to execute the computer readable instructions to:
receive a plurality of second inputs including identification information;
confirm that the identification information is for a patient included in the plurality of patients; and,
extract, using the dispenser, the respective quantity of the respective medication, for the patient included in the plurality of patients, from the respective compartment in accordance with the first modification; or,
terminate extraction, by the dispenser, of the respective quantity of the respective medication, for the patient included in the plurality of patients, from the respective compartment in accordance with the first modification.

17. A computer-based system for controlling dispensing of medications, comprising:
a service entity including a first computer with:
a first processor; and,
a first memory element configured to store first computer readable instructions; and,
a dispensing apparatus including:
a cassette including a plurality of compartments arranged to hold a plurality of stored medications;
a second computer including:
a second processor; and,
a second memory element configured to store second computer readable instructions; and,
a dispenser, wherein:
the first processor is configured to execute the first computer readable instructions to:
receive at least one first input, including at least one prescription for at least one medication, from at least one health care provider or pharmacy entity providing the at least one medication;
create information including:
a respective dosage for each medication included in the at least one medication; and,
at least one time span and respective point in time within the at least one time span for dispensing at least a portion of the at least one medication, or at least one parameter for dispensing at least a portion of the at least one medication on a pro re nata (PRN) basis; and,
transmit the information to the second computer,
the second processor is configured to execute the second computer readable instructions to extract, using the dispenser, medications stored in the plurality of compartments according to the information;
the first processor is configured to execute the first computer readable instructions to:
receive a second input including a change to the respective dosage, the at least one time span, or the at least one parameter;
modify the information to include the second input; and,
transmit the modified information to the second computer, and,
the second processor is configured to execute the second computer readable instructions to extract, using the dispenser, medications stored in the plurality of compartments according to the modified information.

18. A computer-based method for dispensing medications, comprising:
storing in a memory element for a first computer for a dispensing apparatus:
computer readable instructions; and,
first information for a plurality of medications, the first information including:
a first respective dosage for each medication in the plurality of medications; and,
a plurality of time spans, including respective points in time within each time span, for dispensing a portion of the plurality of medications; or,
at least one parameter for dispensing a portion of the plurality of medications on a pro re nata (PRN) basis;
executing, using a processor for the first computer, the computer readable instructions to determine that the first information includes instructions to extract a first medication, included in the portion of the plurality of medications, from a first compartment included in a plurality of compartments for a cassette for the dispensing apparatus, the plurality of compartments arranged to hold a plurality of stored medications;
executing, using the processor, the computer readable instructions to:
receive, from a second computer remote from the dispensing apparatus, a first input including a first modification to the first information for the first medication; or,
create a first modification to the first information for the first medication; and,
executing, using the processor, the computer readable instructions to:
determine that a first stored medication in the first compartment is the same as the first medication; and,
extract, using a dispenser for the dispensing apparatus, a first quantity of the first stored medication from the first compartment in accordance with the first modification; or,
terminate extraction, by the dispenser, of the first stored medication from the first compartment in accordance with the first modification.

19. The computer-based method of claim 18, wherein the first input includes second information provided by:
a health care provider; or,
a pharmacy entity that supplied the first medication; or,
a governmental agency regulating manufacture or distribution of the first medication.

20. The computer-based method of claim 18, wherein:
the first information includes instructions to extract the first respective dosage of the first medication at a first time span included in the plurality of time spans; and,
the first modification identifies a second time span with a first point in time, the method further comprising executing, using the processor, the computer readable instructions to:
extract, using the dispenser and within the second time span:
the first quantity of the first stored medication from the first compartment; or,
a second quantity, different from the first quantity, of the first stored medication from the first compartment.

21. The computer-based method of claim 20, wherein the second time span is included in the plurality of time spans.

22. The computer-based method of claim 20, further comprising:
executing, using the processor, the computer readable instructions to block, using the dispenser, extraction of the first medication within the first time span.

23. The computer-based method of claim 20, wherein:
the second time span precedes the first time span in a chronological sequence; or,
the second time span follows the first time span in a chronological sequence.

24. The computer-based method of claim 20,
wherein the first input includes the second time span or the second quantity; or,
the method further comprising:
executing, using the processor, the computer readable instructions to calculate the second time span or the second quantity.

25. The computer-based method of claim 18,
further comprising:
executing, using the processor, the computer readable instructions to create data regarding compliance with the first respective dosages, the plurality of time spans, or the at least one parameter; and,
further comprising:
executing, using the processor, the computer readable instructions to create the first modification using the data; or,
further comprising:
executing, using the processor, the computer readable instructions to transmit the data to the second computer; and,
creating, using the second computer and the data, the first input.

26. The computer-based method of claim 18, wherein:
the first information includes instructions to extract the first respective dosage of the first medication at a time span included in the plurality of time spans and respective points in time; and,
the first modification identifies a second dosage of the first medication, the method further comprising:
executing, using the processor, the computer readable instructions to extract, using the dispenser, the second dosage of the first stored medication from the first compartment within the first time span,
wherein the first input includes the second dosage; or,
the method further comprising:
executing, using the processor, the computer readable instructions to calculate the second dosage.

27. The computer-based method of claim 18,
further comprising:
executing, using the processor, the computer readable instructions to:
determine that the first information includes instructions to extract, using the dispenser, the first respective dosage of the medication at a first time span included in the plurality of time spans; and,
make a determination that the first stored medication:
has not been extracted from the cassette by the dispenser within the first time span; or,
has been extracted from the cassette by the dispenser within the first time span and not removed from the dispenser within a predetermined time period; and,
the method further comprising:
executing, using the processor, the computer readable instructions to create the first modification using the determination; or,
the method further comprising:
executing, using the processor, the computer readable instructions to transmit the determination to the second computer; and,
creating, using the second computer and the determination, the first input.

28. The computer-based method of claim 18,
wherein the first information includes instructions to extract, using the dispenser, the first respective dosage of the medication at a first time span included in the first plurality of time spans;
the method further comprising:
executing, using the processor, the computer readable instructions to make a determination that a second input, requesting extraction of the first medication, has not been received by the dispenser within a second time span before or after the first time span; and,
the method further comprising:
executing, using the processor, the computer readable instructions to create the first modification using the determination; or,
the method further comprising:
executing, using the processor, the computer readable instructions to transmit the determination to the second computer, and,
creating, using the second computer and the determination, the first input.

29. The computer-based method of claim 18, wherein:
the at least one parameter for dispensing the portion of the plurality of medications on a PRN basis includes:
a first parameter specifying a second time span between extractions of the first medication; or,
a second parameter specifying a first cumulative amount of the first medication extracted within a first time period; and,
the first modification includes a change to the first or second parameter.

30. The computer-based method of claim 18,
wherein the first information includes a second respective dosage for a second medication in the plurality of medications and a second time span, included in the plurality of time spans, for dispensing the second;
the method further comprising:
executing, using the processor, the computer readable instructions to make a determination that:
the second respective dosage has not been extracted within the second time span and has been extracted at a point in time outside of the second time span; or,
a cumulative amount of the second medication has been extracted within a third time span; and,
the method further comprising:
executing, using the processor, the computer readable instructions to create the first modification using the determination; or,
the method further comprising:
executing, using the processor, the computer readable instructions to transmit the determination to the second computer; and,
creating, using the second computer and the determination, the first input.

31. The computer-based method of claim 18, further comprising:
executing, using the processor, the computer readable instructions to extract, using the dispenser:
the first respective dosage of the first medication within a first time span included in the plurality of time spans; or,
the first medication in compliance with the at least one parameter;
executing, using the processor, the computer readable instructions to:
determine that a second stored medication in a second compartment included in the plurality of compartments is the same as a second medication included in the plurality of medications; and,
extract, using the dispenser:
a first respective dosage of the second stored medication from the second compartment within a second time span included in the plurality of time spans; or,
the second stored medication in compliance with the at least one parameter, wherein the first modification includes a change to the first respective dosage of the first medication, or the first time span, or the at least one parameter, the method further comprising:
executing, using the processor, the computer readable instructions to modify, according to the first modification: the first respective dosage of the second medication, or the second time span, or the at least one parameter with respect to the second medication.

32. The computer-based method of claim 18,
wherein:
the dispenser includes a user interface; and,
the information includes an identity of a patient for whom the first medication is prescribed;
the method further comprising:
executing, using the processor, the computer readable instructions to receive, from the user interface, a second input including data regarding a parameter related to health of the patient; and,
the method further comprising:
executing, using the processor, the computer readable instructions to create the first modification using the data; or,
the method further comprising:
executing, using the processor, the computer readable instructions to transmit the data to the second computer; and,
creating, using the second computer and the data, the first input.

33. The computer-based method of claim 18, wherein:
the plurality of compartments is arranged to store a respective stored medication for a plurality of patients;
the first information includes, for each patient in the plurality of patients:
first respective dosage for a respective medication in the plurality of medications; and,
a respective time span included in the plurality of time spans for dispensing the respective medication; or,
at least one respective parameter for dispensing the respective medication on a PRN basis, the method further comprising:
executing, using the processor, the computer readable instructions to determine that the information includes respective instructions to extract each respective from a respective compartment included in the plurality of compartments; and,
executing, using the processor, the computer readable instructions to:
receive a plurality of second inputs including identification information;
confirm that the identification information is for a patient included in the plurality of patients; and,
extract, using the dispenser, the respective quantity of the respective medication, for the patient included in the plurality of patients, from the respective compartment in accordance with the first modification; or,
terminate extraction, by the dispenser, of the respective quantity of the respective medication, for the patient included in the plurality of patients, from the respective compartment in accordance with the first modification.

34. A computer-based method for controlling dispensing of medications, comprising:
storing first computer readable instructions in a first memory element for a first computer for a service entity;
storing second computer readable instructions in a second memory element for a second computer for a dispensing apparatus;
executing, using a first processor for the first computer, the first computer readable instructions to:
receive at least one first input, including at least one prescription for at least one medication, from at least one health care provider or pharmacy entity providing the at least one medication;
create information including:
a respective dosage for each medication included in the at least one medication; and,
at least one time span and respective point in time within the at least one time span for dispensing at least a portion of the at least one medication, or at least one parameter for dispensing at least a portion of the at least one medication on a pro re nata (PRN) basis; and,
transmit the information to the second computer;
executing, using a second processor for the second computer, the second computer readable instructions to extract, using a dispenser for the dispensing apparatus, medications stored in a plurality of compartments for a cassette for the dispensing apparatus according to the information;
executing, using the first processor, the first computer readable instructions to:
receive a second input including a change to the respective dosage, the at least one time span, or the at least one parameter;
modify the information to include the second input; and,
transmit the modified information to the second computer; and,
executing, using the second processor, the second computer readable instructions to extract, using a dispenser for the dispensing apparatus, medications stored in the plurality of compartments according to the modified information.
